(19) United States
(12) Patent Application Publication
(10) Pub. No.: US 2014/0289002 A1
(43) Pub. Date: Sep. 25, 2014

(54) METHODS FOR IDENTIFYING AND PROVIDING NOTIFICATION ABOUT WEB CONTENT ASSOCIATED WITH AN ORGANIZATION AND DEVICES THEREOF

(71) Applicant: Infosys Limited, Bangalore (IN)

(72) Inventors: Atul Dubey, Ranchi (IN); Manu Sinha, Hapur (IN); Manish Kumar, Bangalore (IN)

(73) Assignee: Infosys Limited, Bangalore (IN)

(21) Appl. No.: 14/220,694

(22) Filed: Mar. 20, 2014

(30) Foreign Application Priority Data
Mar. 20, 2013 (IN) 1205/CHE/2013

(51) Int. Cl. G06Q 30/02

(52) U.S. Cl. CPC G06Q 30/0201
USPC 705/7.29

(57) ABSTRACT

A method, non-transitory computer readable medium, and apparatus that identifies and provides notification about web content associated with an organization includes identifying one or more sets of web content which contains one or more organization keywords. At least a portion of each of the identified one or more sets of web content is extracted. One or more business units within each of one or more organizations and one or more business words for each of the one or more business units are obtained. One or more of the business words are associated with one or more of the extracted portions of the one or more sets of web content. Each of the extracted portions of the one or more sets of web content are provided to a designated recipient computing device based on the association of the one or more business words with the one or more of the extracted portions of the one or more sets of web content.

This application claims the benefit of Indian Patent Application Filing No. 1205/CHE/2013, filed Mar. 20, 2013, which is hereby incorporated by reference in its entirety.

### FIELD

This technology generally relates to methods and devices for identifying and providing notification about web content associated with an organization.

### BACKGROUND

In the current Internet age, organizations can quickly be subjected to negative comments, such as complaints, posted by customers or other entities. Unfortunately, these posted negative comments can quickly lead to a stream of bad publicity for an organization.

Accordingly, organizations need to be ready to quickly address posted negative comments in a timely manner. Unfortunately, to date the existing solutions do not adequately assist organizations with identifying and addressing this bad publicity in timely manner. In particular, the existing technologies fail to assist in effectively connecting the particular negative comment with the relevant employee in the organization who could must quickly and appropriately respond and stop this negative publicity from growing.

### SUMMARY

A method for identifying and providing notification about web content associated with an organization includes identifying by a web content management computing device one or more sets of web content which contains one or more organization keywords. At least a portion of each of the identified one or more sets of web content is extracted by the web content management computing device. One or more business units within each of one or more organizations and one or more business words for each of the one or more business units are obtained by the web content management computing device. One or more of the business words are associated by the web content management computing device with one or more of the extracted portions of the one or more sets of web content. Each of the extracted portions of the one or more sets of web content are provided by the web content management computing device to a designated recipient computing device based on the association of the one or more business words with the one or more of the extracted portions of the one or more sets of web content.

A non-transitory computer readable medium having stored thereon instructions for identifying and providing notification about web content associated with an organization comprising machine executable code which when executed by at least one processor, causes the processor to perform steps including identifying one or more sets of web content which contains one or more organization keywords. At least a portion of each of the identified one or more sets of web content is extracted. One or more business units within each of one or more organizations and one or more business words for each of the one or more business units are obtained. One or more of the business words are associated with one or more of the extracted portions of the one or more sets of web content. Each of the extracted portions of the one or more sets of web content are provided to a designated recipient computing device based on the association of the one or more business words with the one or more of the extracted portions of the one or more sets of web content.

A web content management computing apparatus comprising a memory coupled to one or more processors which are configured to execute programmed instructions stored in the memory identifying one or more sets of web content which contains one or more organization keywords. At least a portion of each of the identified one or more sets of web content is extracted. One or more business units within each of one or more organizations and one or more business words for each of the one or more business units are obtained. One or more of the business words are associated with one or more of the extracted portions of the one or more sets of web content. Each of the extracted portions of the one or more sets of web content are provided to a designated recipient computing device based on the association of the one or more business words with the one or more of the extracted portions of the one or more sets of web content.

This technology provides a number of advantages including providing more effective methods, non-transitory computer readable medium and devices for identifying and providing notification about web content associated with one or more business processes. With this technology, negative comments are quickly identified and then associated not only with a particular organization, but to the particular client computing device of the person in the organization who can appropriately address the negative comment and stop this negative publicity from growing. Once identified, this identified client computing device is directly connected to respond to the criticism in a timely manner thus improving customer responsiveness, addressing relevant inquiries and concerned, and being connected to the users on an ongoing basis.

### BRIEF DESCRIPTION OF THE DRAWINGS

FIG. 1 is an exemplary environment with a web content management computing device that identifies and provides notification about web content associated with an organization; and

FIG. 2 is a flow chart of an exemplary method for identifying and providing notification about web content associated with an organization.

### DETAILED DESCRIPTION

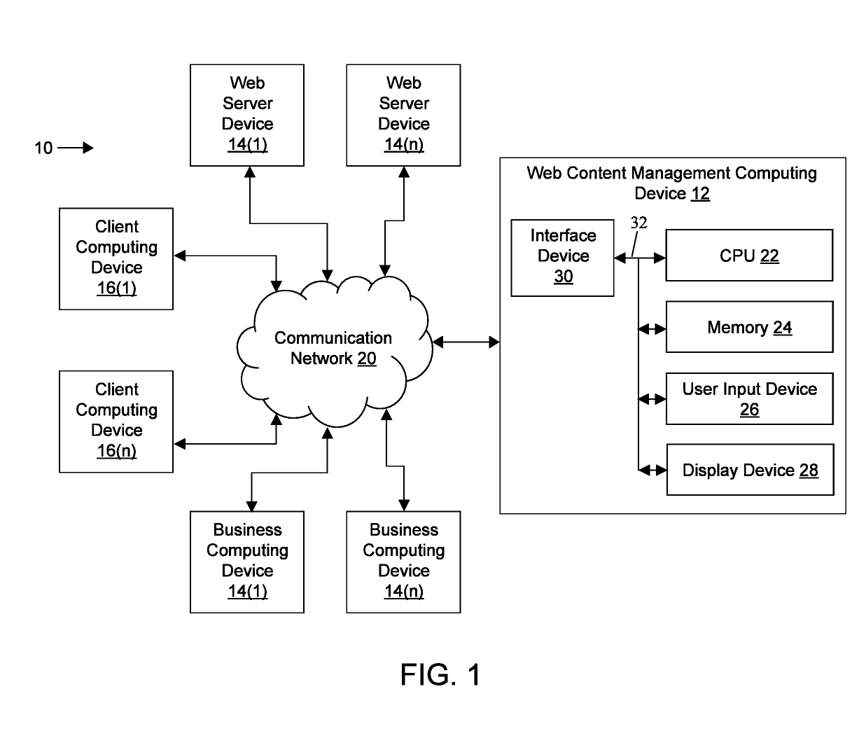

An exemplary environment 10 with a web content management computing device 12 that identifies and provides notification about web content associated with an organization is illustrated in FIG. 1. The environment 10 includes the web content management server device 12, a plurality of web server devices 14(1)-14(n), a plurality of client computing devices 16(1)-16(n), and a plurality of business computing devices 18(1)-18(n) which are all coupled together by one or more communication networks 20, although this environment can include other numbers and types of systems, devices, components, and elements in other configurations. This technology provides a number of advantages including providing more effective methods, non-transitory computer readable medium and devices for identifying and providing notification about web content associated with an organization.

The web content management computing device 12 includes a central processing unit (CPU) or processor 22, a memory 24, a user input device 26, a display device 28, and an interface device 30 which are coupled together by a bus or other link 32, although other numbers and types of systems, devices, components, and elements in other configurations and locations can be used. The processor 22 in the web content management computing device 12 executes a program of stored instructions for one or more aspects of the present technology as described and illustrated by way of the examples herein, although other types and numbers of processing devices and logic could be used to execute or otherwise implement these steps and/or the processor could execute other numbers and types of programmed instructions.

The memory 24 of the web content management computing device 12 stores these programmed instructions and data for one or more aspects of the present technology as described and illustrated herein, although some or all of the programmed instructions and data could be stored and executed elsewhere and other types and amounts of instructions and data could be stored. A variety of different types of memory storage devices, such as a random access memory (RAM) or a read only memory (ROM) in the system or a floppy disk, flash memory, solid state memory, hard disk, CD ROM, DVD ROM, or other computer readable medium which is read from and written to by a magnetic, optical, or other reading and writing system that is coupled to the processor 22 can be used for the memory 24. Additionally, these exemplary processes as illustrated and described herein could be executed partly or wholly by other systems, devices, components or other elements.

The user input device 26 of the web content management computing device 12 comprise a keyboard and computer mouse, although other types and numbers of user input devices could be used. The display device 28 of the web content management device 12 is a computer screen display device used to provide a visual display of text, images and other information for an operator of the web content management computing device 12, although other types and numbers of displays could be used.

The interface device 30 of the web content management computing device 12 is used to operatively couple and communicate between the web content management computing device 12 and the plurality of web server devices 14(1)-14(n), the plurality of client computing devices 16(1)-16(n), and the plurality of business computing devices 18(1)-18(n) via the one or more communications networks 20 and the USB connection in this particular example, although other types and numbers of communication networks or systems with other types and numbers of connections and configurations could be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The plurality of web server devices 14(1)-14(n) each include a central processing unit (CPU) or processor, a memory, and an interface device which are coupled together by a bus or other link, although the each of the plurality of web server devices 14(1)-14(n) could comprise other numbers and types of systems, devices, elements, and components in other configurations. The processor in each of the plurality of web server devices 14(1)-14(n) may execute a program of stored instructions for one or more aspects of the present technology as described and illustrated by way of the examples herein, although other types and numbers of processing devices and logic could be used and the processor could execute other numbers and types of programmed instructions.

The memory in each of the plurality of web server devices 14(1)-14(n) may store these programmed instructions and data for one or more aspects of the present technology as described and illustrated herein, although some or all of the programmed instructions and data could be stored and executed elsewhere and other types and amounts of instructions and data could be stored. A variety of different types of memory storage devices, such as a random access memory (RAM) or a read only memory (ROM) in the system or a floppy disk, flash memory, solid state memory, hard disk, CD ROM, DVD ROM, or other computer readable medium which is read from and written to by a magnetic, optical, or other reading and writing system that is coupled to the processor in each of the plurality of web server devices 14(1)-14(n), can be used for the memory in each of the plurality of web server devices 14(1)-14(n).

The interface device in each of the plurality of web server devices 14(1)-14(n) is used to operatively couple and communicate between each of the plurality of web server devices 14(1)-14(n) and the web content management computing device 12, the plurality of client computing devices 16(1)-16(n), and the plurality of business computing devices 18(1)-18(n), although the interface device in each of the plurality of web server devices 14(1)-14(n) can be used to couple each of the plurality of web server devices 14(1)-14(n) to other types and numbers of systems, devices, components and other elements. Additionally, the interface device in each of the plurality of web server devices 14(1)-14(n) could use other types and numbers of communication networks or systems with other types and numbers of connections and configurations. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The plurality of client computing devices 16(1)-16(n) each include a central processing unit (CPU) or processor, a memory, a user input device, a display device, and an interface device which are coupled together by a bus or other link, although the each of the plurality of client computing devices 16(1)-16(n) could comprise other numbers and types of systems, devices, elements, and components in other configurations. The processor in each of the plurality of client computing devices 16(1)-16(n) may execute a program of stored instructions for one or more aspects of the present technology as described and illustrated by way of the examples herein, although other types and numbers of processing devices and logic could be used and the processor could execute other numbers and types of programmed instructions.

The memory in each of the plurality of client computing devices 16(1)-16(n) may store these programmed instructions and data for one or more aspects of the present technology as described and illustrated herein, although some or all of the programmed instructions and data could be stored and executed elsewhere and other types and amounts of instructions and data could be stored. A variety of different types of memory storage devices, such as a random access memory (RAM) or a read only memory (ROM) in the system or a floppy disk, flash memory, solid state memory, hard disk, CD ROM, DVD ROM, or other computer readable medium which is read from and written to by a magnetic, optical, or other reading and writing system that is coupled to the processor in each of the plurality of client computing devices 16(1)-16(n), can be used for the memory in each of the plurality of client computing devices 16(1)-16(n).

The user input device in each of the plurality of client computing devices 16(1)-16(n) comprise a keyboard and computer mouse, although other types and numbers of user input devices could be used. The display device in each of the plurality of client computing devices 16(1)-16(n) is a computer screen display device used to provide a visual display of text, images and other information for an operator of each of the plurality of client computing devices 16(1)-16(n), although other types and numbers of displays could be used.

The interface device in each of the plurality of client computing devices 16(1)-16(n) is used to operatively couple and communicate between each of the plurality of client computing devices 16(1)-16(n) and the web content management computing device 12, each of the plurality of web server devices 14(1)-14(n), and each of the plurality of business computing devices 18(1)-18(n), although the interface device in each of the plurality of web server devices 14(1)-14(n) can be used to couple each of the plurality of web server devices 14(1)-14(n) to other types and numbers of systems, devices, components and other elements. Additionally, the interface device in each of the plurality of web server devices 14(1)-14(n) could use other types and numbers of communication networks or systems with other types and numbers of connections and configurations. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The plurality of business computing devices 18(1)-18(n) each include a central processing unit (CPU) or processor, a memory, a user input device, a display device, and an interface device which are coupled together by a bus or other link, although each of the business computing devices 18(1)-18(n) could comprise other numbers and types of systems, devices, elements, and components in other configurations. The processor in each of the plurality of business computing devices 18(1)-18(n) may execute a program of stored instructions for one or more aspects of the present technology as described and illustrated by way of the examples herein, although other types and numbers of processing devices and logic could be used and the processor could execute other numbers and types of programmed instructions.

The memory in each of the plurality of business computing devices 18(1)-18(n) may store these programmed instructions and data for one or more aspects of the present technology as described and illustrated herein, although some or all of the programmed instructions and data could be stored and executed elsewhere and other types and amounts of instructions and data could be stored. A variety of different types of memory storage devices, such as a random access memory (RAM) or a read only memory (ROM) in the system or a floppy disk, flash memory, solid state memory, hard disk, CD ROM, DVD ROM, or other computer readable medium which is read from and written to by a magnetic, optical, or other reading and writing system that is coupled to the processor in each of the plurality of business computing devices 18(1)-18(n), can be used for the memory in each of the plurality of business computing devices 18(1)-18(n).

The user input device in each of the plurality of business computing devices 18(1)-18(n) comprises a keyboard and computer mouse, although other types and numbers of user input devices could be used. The display device in each of the plurality of business computing devices 18(1)-18(n) is a computer screen display device used to provide a visual display of text, images and other information for an operator of each of the plurality of business computing devices 18(1)-18(n), although other types and numbers of displays could be used.

The interface device in each of the plurality of business computing devices 18(1)-18(n) is used to operatively couple and communicate between each of the business computing devices 18(1)-18(n) and the web content management computing device 12, each of the plurality of web server devices 14(1)-14(n), and each of the plurality of client computing devices 16(1)-16(n), although the interface device in each of the plurality of business computing devices 18(1)-18(n) can be used to couple each of the plurality of business computing devices 18(1)-18(n) to other types and numbers of systems, devices, components and other elements. Additionally, the interface device in each of the plurality of business computing devices 18(1)-18(n) could use other types and numbers of communication networks or systems with other types and numbers of connections and configurations. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

Although examples of the web content management server device 12, the plurality of web server devices 14(1)-14(n), the plurality of client computing devices 16(1)-16(n), and the plurality of business computing devices 18(1)-18(n) are described herein, each of these devices can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof

The examples may also be embodied as non-transitory computer readable medium having instructions stored thereon for one or more aspects of the present technology as described and illustrated by way of the examples herein, as described herein, which when executed by a processor, cause the processor to carry out the steps necessary to implement the methods of the examples, as

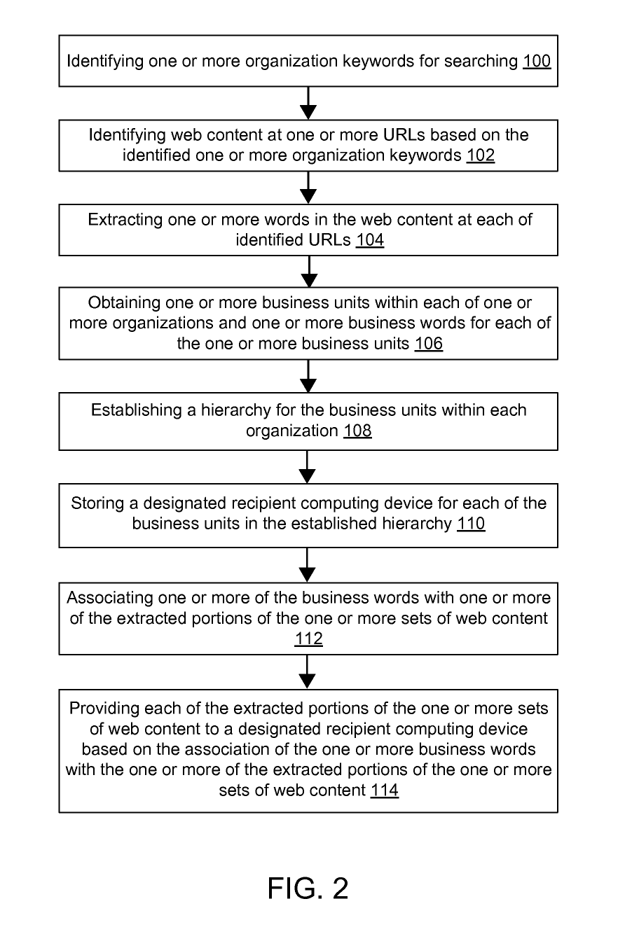

An exemplary method for identifying and providing notification about web content associated with one or more business processes will now be described with reference to FIGS. 1-2. The recited order of processing steps is exemplary and is not intended to limit the claimed processes to any particular order or one or more sequences. The steps set forth below may be executed in other orders, sequences, and manners.

In step 100, the content management computing device 12 identifies one or more organization keywords, such as the name or an organization and identifiers of different products and services offered by the organization, for searching blogs and other Internet content. In this particular example, the one or more organization keywords are obtained by operator input and are stored by the content management computing device 12, although other manners for obtaining the organization keywords for each organization can be used.

In step 102, the content management computing device 12 uses a search engine to identify web content at one or more URLs based on the identified one or more organization keywords. When one of the organization keywords is found in web content, the URL for the web content along with the one or more organization keywords found in the web content are stored by the content management computing device 12, although other types and amount of content and content identifiers could be stored.

In step 104, the content management computing device 12 uses a page content crawler to extract and stores one or more words from the web content at each of identified URLs near each of the identified organization keywords. In this particular example, the content management computing device 12 extracts a set number of words before and after each of the identified organization keywords from the web content at each of the identified URLs, although other manners for extracting content could be used, such as identifying and extracting the paragraph in which one of the organization key words was found. Additionally, the one or more words from the web content could be extracted dynamically by the content management computing device 12 during the association step.

In step 106, the content management computing device 12 obtaining one or more business units within each of one or more organizations and one or more business words for each of the one or more business units from memory, although other aspects of the organization could be obtained and in other manners. By way of example only, the one or more business units and the one or more business words for each of the one or more business units could be obtained by operator input and stored by the content management computing device 12.

In step 108, the content management computing device 12 establishes a hierarchy for the obtained business units within each organization, although other manners for organizing the identified business units could be used. For example, an organization may have two different divisions and each division could have multiple operating entities which each could have other hierarchies.

In step 110 the content management computing device 12 identified a designated recipient computing device from a stored table of potential recipients for each of the business units in the established hierarchy for each organization and stores the association, although other manners for identifying a designated recipient could be used. By way of example only, the content management computing device 12 could obtain the designated recipient for each of the business units in the established hierarchy for each organization from operator input.

In step 112, the content management computing device 12 uses an association algorithm to associate one or more of the business words with one or more of the extracted portions of the one or more sets of web content at each of identified URLs, although other manners for identifying one of the business units can be used. Additionally, the content management computing device 12 determines a designated recipient computing device from the stored table based on the association, although other manners for determining one or more designated recipients can be used. By way of example only, if the association identifies multiple business units, then the content management computing device 12 may determine which of the identified business units has the most direct responsibility for the identified extracted web content and then will assign it to that business unit.

In step 114, the content management computing device 12 provides the one or more sets of identified web content to the identified designated recipient computing device based on the association of the one or more business words with the one or more of the extracted portions of the one or more sets of web content and the established hierarchy, although other types and numbers of operations could be performed. Optionally, the content management computing device 12 may provide for operator input to review and revise the designated recipient computing device and/or add other designated recipients.

Accordingly, as illustrated and described with the examples herein this technology provides more effective methods, non-transitory computer readable medium and devices for identifying and providing notification about web content associated with one or more business processes. With this technology, negative comments are quickly identified and then associated not only with a particular organization, but to the particular client computing device of the person in the organization who can appropriately address the negative comment and stop this negative publicity from growing. Once identified, this identified client computing device is directly connected to respond to the criticism in a timely manner thus improving customer responsiveness, addressing relevant inquiries and concerned, and being connected to the users on an ongoing basis.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for identifying and providing notification about web content associated with an organization, the method comprising:
identifying by a web content management computing device one or more sets of web content which contains one or more organization keywords;
extracting by the web content management computing device at least a portion of each of the identified one or more sets of web content;
obtaining by the web content management computing device one or more business units within each of one or more organizations and one or more business words for each of the one or more business units;
associating by the web content management computing device one or more of the business words with one or more of the extracted portions of the one or more sets of web content; and
providing by the web content management computing device each of the extracted portions of the one or more sets of web content to a designated recipient computing device based on the association of the one or more business words with the one or more of the extracted portions of the one or more sets of web content.

2. The method as set forth in claim 1 further comprising receiving by a web content management computing device the one or more organization keywords.

3. The method as set forth in claim 1 wherein the identifying one or more sets of web content further comprises identifying by the web content management computing device a URL associated with each of the identified one or more sets of web content, wherein the extracting further comprises utilizing by the web content management computing the identified URL to obtain and extract the at least a portion of each of the identified one or more sets of web content.

4. The method as set forth in claim 1 wherein the extracting further comprises extracting by the web content management computing device at least a first number of words about each of the identified one or more organization keywords in each of the identified one or more sets of web content.

5. The method as set forth in claim 1 wherein the obtaining one or more business units within each of one or more organizations and the one or more business words for each of the one or more business units further comprises obtaining by the web content management computing device the one or more business units and the one or more business words from one or more stored tables.

6. The method as set forth in claim 1 further comprising storing by the web content management computing device a designated recipient computing device for each of the one or more business units within each of one or more organizations.

7. The method as set forth in claim 1 further comprising storing by the web content management computing device a hierarchy for the one or more business units within each of one or more organizations, wherein the providing further comprises providing by the web content management computing device each of the extracted portions of the one or more sets of web content to the designated recipient computing device further based on the stored hierarchy.

8. A non-transitory computer readable medium having stored thereon instructions for identifying and providing notification about web content associated with an organization comprising machine executable code which when executed by at least one processor, causes the processor to perform steps comprising:
identifying one or more sets of web content which contains one or more organization keywords;
extracting at least a portion of each of the identified one or more sets of web content;
obtaining one or more business units within each of one or more organizations and one or more business words for each of the one or more business units;
associating one or more of the business words with one or more of the extracted portions of the one or more sets of web content; and
providing each of the extracted portions of the one or more sets of web content to a designated recipient computing device based on the association of the one or more business words with the one or more of the extracted portions of the one or more sets of web content.

9. The medium as set forth in claim 8 further comprising receiving the one or more organization keywords.

10. The medium as set forth in claim 8 wherein the identifying one or more sets of web content further comprises identifying a URL associated with each of the identified one or more sets of web content, wherein the extracting further comprises utilizing the identified URL to obtain and extract the at least a portion of each of the identified one or more sets of web content.

11. The medium as set forth in claim 8 wherein the extracting further comprises extracting at least a first number of words about each of the identified one or more organization keywords in each of the identified one or more sets of web content.

12. The medium as set forth in claim 8 wherein the obtaining one or more business units within each of one or more organizations and the one or more business words for each of the one or more business units further comprises obtaining the one or more business units and the one or more business words from one or more stored tables.

13. The medium as set forth in claim 8 further comprising storing a designated recipient computing device for each of the one or more business units within each of one or more organizations.

14. The medium as set forth in claim 8 further comprising storing a hierarchy for the one or more business units within each of one or more organizations, wherein the providing further comprises providing each of the extracted portions of the one or more sets of web content to the designated recipient computing device further based on the stored hierarchy.

15. A web content management computing apparatus comprising a memory coupled to one or more processors which are configured to execute programmed instructions stored in the memory comprising:
identifying one or more sets of web content which contains one or more organization keywords;
extracting at least a portion of each of the identified one or more sets of web content;
obtaining one or more business units within each of one or more organizations and one or more business words for each of the one or more business units;
associating one or more of the business words with one or more of the extracted portions of the one or more sets of web content; and
providing each of the extracted portions of the one or more sets of web content to a designated recipient computing device based on the association of the one or more business words with the one or more of the extracted portions of the one or more sets of web content.

16. The apparatus as set forth in claim 15 wherein the one or more processors is further configured to execute programmed instructions stored in the memory further comprising receiving the one or more organization keywords.

17. The apparatus as set forth in claim 15 wherein the one or more processors is further configured to execute programmed instructions stored in the memory for the identifying one or more sets of web content further comprises identifying a URL associated with each of the identified one or more sets of web content, wherein the extracting further comprises utilizing the identified URL to obtain and extract the at least a portion of each of the identified one or more sets of web content.

18. The apparatus as set forth in claim 15 wherein the one or more processors is further configured to execute programmed instructions stored in the memory for the extracting further comprises extracting at least a first number of words about each of the identified one or more organization keywords in each of the identified one or more sets of web content.

19. The apparatus as set forth in claim 15 wherein the one or more processors is further configured to execute programmed instructions stored in the memory for the obtaining one or more business units within each of one or more organizations and the one or more business words for each of the one or more business units further comprises obtaining the one or more business units and the one or more business words from one or more stored tables.

20. The apparatus as set forth in claim 15 wherein the one or more processors is further configured to execute programmed instructions stored in the memory further comprising storing a designated recipient computing device for each of the one or more business units within each of one or more organizations.

21. The apparatus as set forth in claim 15 wherein the one or more processors is further configured to execute programmed instructions stored in the memory further comprising storing a hierarchy for the one or more business units within each of one or more organizations, wherein the providing further comprises providing each of the extracted portions of the one or more sets of web content to the designated recipient computing device further based on the stored hierarchy.
